(19) United States
(12) Patent Application Publication
(10) Pub. No.: US 2026/0354466 A1
(43) Pub. Date: Nov. 12, 2026

(54) HEATER FOR AN AEROSOL PROVISION DEVICE

(71) Applicant: Nicoventures Trading Limited, London (GB)

(72) Inventors: Tom WOODMAN, London (GB); Juan Esteban Paz JAUREGUI, London (GB)

(21) Appl. No.: 19/125,026

(22) PCT Filed: Oct. 30, 2023
(86) PCT No.: PCT/EP2023/080287

§ 371 Date: Apr. 28, 2025

(30) Foreign Application Priority Data
Oct. 31, 2022 (GB) 2216099.8

(51) Int. Cl. A24F 40/46; A24F 40/70; H05B 3/02

(52) U.S. Cl. CPC A24F 40/46; A24F 40/70; H05B 3/02

(57) ABSTRACT

A heater for an aerosol provision device configured to heat at least a portion of an article containing aerosol generating material, wherein the heater comprises: an elongate housing; a heating element located within the elongate housing; and a filler located within in the elongate housing; wherein the heating element is held in the elongate housing by the filler; wherein the filler comprises a filler material and a particulate material; and the particulate material is electrically insulative and has a thermal capacity that is lower than that of the filler material.

### CROSS-REFERENCE TO RELATED APPLICATIONS

This present application is a National Phase entry of PCT Application No.

PCT/EP2023/080287, filed Oct. 30, 2023, which claims priority from Great Britian Application No. 2216099.8, filed Oct. 31, 2022, each of which are fully incorporated herein by reference in their entireties.

### TECHNICAL FIELD

The present invention relates to a heater for an aerosol provision device, an aerosol provision device, an aerosol provision system, a method of manufacturing a heater for an aerosol provision device and a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use resistive heating systems as heaters to create an aerosol from a suitable medium. Separately, induction heating systems are known to be used as heaters.

### SUMMARY

According to an aspect there is provided a heater for an aerosol provision device configured to heat at least a portion of an article containing aerosol generating material, wherein the heater comprises: an elongate housing; a heating element located within the elongate housing; and a filler located within in the elongate housing; wherein the heating element is held in the elongate housing by the filler; wherein the filler comprises a filler material and a particulate material; and the particulate material is electrically insulative and has a thermal capacity that is lower than that of the filler material.

The elongate housing member may comprise a bore, and the heating element and the filler may be located within the bore. The bore may define an inner void of the heater. The filler may be provided between at least a portion of the inner surface of the elongate housing and a portion of the heating element. The heating element may be free from contact with an inner surface of the elongate housing.

The at least one discrete portion of filler may extend along a majority of a length of the heating element. The at least one discrete portion of filler may extend along 75% of a length of the heating element. The at least one discrete portion of filler may extend along 90% of a length of the heating element. The at least one discrete portion of filler may extend along substantially the whole length of a length of the heating element.

A single discrete portion of filler may be provided. The single discrete portion of filler may be configured to occupy at least part of the space within a heater coil. A single discrete portion of filler may be provided, and the filler and heater element may substantially fill an inner void within the elongate housing.

At least two discrete portions of filler may be provided.

The elongate housing may define a longitudinal axis, and the at least two discrete portions of filler may be spaced from each other along the longitudinal axis. There may be an air gap between each of the discrete portions of filler.

At least one discrete portion of filler may be provided at a first end of the heating element. The portion of discrete filler may substantially surround the first end of the heating element. One discrete portion of filler material may surround a distal end of the heating element. One discrete portion of filler material may surround a proximal end of the heating element.

At least one discrete portions of filler may be provided at a second end of the heating element. The portion of discrete filler may substantially surround the second end of the heating element.

At least two discrete portions of filler may be provided. The at least two discrete portions of filler may extend axially along an inner surface of the elongate housing, such that a generally axially orientated passage is provided between adjacent portions of filler.

At least two discrete portions of filler may be provided, the at least two discrete portions of filler may be axially spaced from each other. There may be an air gap between each of the at least two masses.

The particulate material may have a specific thermal capacity of between about 700 J·kg−1·K−1and about 1100 J·kg−1·K−1. The particulate material may have a specific thermal capacity of between about 750 J·kg−1·K−1and about 900 J·kg−1·K−1

The particulate material may comprise microspheres. It will be understood that microspheres are engineered spherical particles with dimensions on the micro scale, typically between 1 and 1000 μm

The particulate material may comprise hollow microspheres.

The particulate material may have a median particle size (also referred to as the median particle diameter or D50 value) of less than about 500 μm. The particulate material may have a median particle size of less than about 350 μm. The particulate material may have a median particle size of less than about 250 μm.

The particulate material may have a median particle size (also referred to as the median particle diameter or D50 value) of about 15 to about 500 μm.

The particulate material may have a median particle size of about 15 to about 65 μm. The particulate material may have a median particle size of about 25 to about 5 μm, or from about 35 to about 50 μm.

The particulate material may have D90 value of about 20 to about 110 μm, from about 40 to about 85 μm, or from about 50 to about 70 μm.

A distance D between the inner surface of the elongate housing and an outer surface of the heating element may be smaller than a median particle size of the particular material.

A median particle size of the particulate material may be greater than a distance D between the inner surface of the elongate housing and an outer surface of the heating element. The distance D may be between about 1 μm and about 65 μm, or may be between about 1 μm and about 50 μm or may be between about 5 μm and about 25 μm. The particulate material may have a median particle size greater than D.

The particulate material may have a density of less than about 0.65g/cm 3 , such as from about 0.1 g/cm3 to about 0.5 g/cm3.

The filler may comprise any amount of particulate material, such as from about 1 wt. % to about 99 wt. %, from about 10 wt. % to about 90 wt. %, from about 20 to about 80 wt. %, from about 25 wt. % to about 75 wt. %, or from about 30 wt. % to about 70 wt. %.

The weight ratio of filler material to particulate material may range from about 1:10 to about 10:1, such as from about 1:5 to about 5:1 or from about 1:2 to about 2:1.

The filler may comprise any amount of particulate material, such as from about 10 wt. % to about 90 wt. %, from about 20 to about 80 wt. %, or from about 25 wt. % to about 75 wt. %, or from about 30 wt. % to about 70 wt. %.

The filler may comprise any amount of particulate material, from about 10% to about 90% by volume, from about 20% to about 80% by volume, from about 30% to about 70% % by volume

The particulate material may comprise glass particles. The particulate material may be glass microspheres. The glass microspheres may be hollow glass microspheres. The glass microspheres may have a median particle size (also referred to as the median particle diameter, D50) of about 15 to about 65 μm.

Suitable particulate materials for use in the present invention are commercially available (for example from 3M™, Trelleborg Applied Technologies, Hollowlite Materials Co. Ltd and Poraver). Suitable commercially available glass particulate material having the required thermal capacitance include Glass Bubbles iM16K and iM30K from 3M™, SI-100 from Trelleborg, Hollow Glass Sphere HL Series/HL series from Hollowlite and Poraspheres™ from Poraver. However, other suitable materials are available, and the skilled person could select suitable materials having the required thermal capacitance without difficulty.

The particulate material may comprise fibres and/or strands. The particulate material may comprise glass fibres or glass strands.

The particulate material may comprise amorphous or crystalline materials The particulate material may comprise a combination of microspheres, fibres and/or strands.

The particulate material may comprise ceramic material. The particulate material may comprise ceramic microspheres, fibres or strands. The particulate material may comprise hollow ceramic microspheres.

Suitable commercially available ceramic particulate material having the required thermal capacitance include Extendospheres™ from SphereOne,

The particulate material may comprise silicone material. The particulate material may comprise microspheres, fibres or strands formed from a silicone material.

The filler material may comprise an electrically insulative material. The filler may be a dielectric material. The filler material may comprise an inorganic material. The filler material may comprise a polymer, such as an elastomer, an amorphous thermoplastic polymer or a semi-crystalline thermoplastic. The thermally insulating material may comprise an epoxy resin. For example, a two-component epoxy may be used consisting of a polymer resin and a hardener which when mixed together causes a chemical reaction which cross-links chemical bonds in the polymer chains to create a tough, rigid and strong compound.

The filler may be a preformed element.

The heater element may comprise at least one heater coil.

The heating element may comprise a single coil. The coil may have a constant pitch. The coil may have a variable pitch, wherein a central portion of the coil has less windings per unit length than the two end portions. The heating element may comprise two or more coils. The coil(s) may be helical coils.

The heating element may be a resistive heating element. The heating element may be an inductive heating element.

The heater may be a resistive heater. The heating element may be a resistive heating element. The heating element may be a resistive heating coil.

The heater may be an inductive heating heater. The heating element may be an inductive heating element. The coil may be an inductive coil.

The elongate housing may comprise one or more holes, slots, grooves, apertures or depressions, wherein the one or more holes, slots, grooves, apertures or depressions are provided at a base end of the heater and are at least partially filled with a thermally insulating material.

The one or more holes, slots, grooves, apertures or depressions may be configured to act as a thermal break.

The one or more holes, slots, grooves, apertures or depressions may be located along the length of the elongate housing at a longitudinal position which is intermediate a first longitudinal position corresponding to the longitudinal position of a base end of the heating element and a second longitudinal position an open end of the heater.

The one or more holes, slots, apertures or depressions may be located along the length of the elongate housing at two or more longitudinal positions which are intermediate a first longitudinal position corresponding to the longitudinal position of a base end of the heating element and a second longitudinal position an open end of the heater.

The one or more holes, slots, grooves, apertures or depressions may be provided on an inner surface of the elongate housing. The one or more holes, slots, grooves, apertures or depressions may be provided on an inner surface of an inner void of the elongate housing.

The one or more holes, slots, grooves, apertures or depressions may be provided on an outer surface of the elongate housing

The elongate housing may comprise a mount at a proximal end, and the mount may comprise one or more holes, slots, one or more holes apertures or depressions, wherein the one or more holes, slots, apertures or depressions are at least partially filled with a thermally insulating material.

The thermally insulating material may comprise the filler.

The thermally insulating material may comprise a potting material, an adhesive, a thermosetting plastic, an epoxy resin or a ceramic material. The thermally insulating material may comprise an epoxy resin. For example, a two-component epoxy may be used consisting of a polymer resin and a hardener which when mixed together causes a chemical reaction which cross-links chemical bonds in the polymer chains to create a tough, rigid and strong compound. The thermally insulating material may comprise a polyurethane (“PU”) e.g. a thermoset plastic. This may comprise a two-component compound consisting of a base resin with an isocyanate curing agent. The thermally insulating material may comprise a silicone. For example, silicone rubber may be utilised comprising a synthetic polysiloxane polymer that uses an additive catalyser (such as platinum) to transition from a liquid to a solid state.

According to an aspect, there is provided aerosol provision device configured to heat an article comprising aerosol generating material, the device comprising a heater described above. The aerosol provision device may comprise a heating chamber, in which the heater is provided.

The aerosol provision device may comprise a power source, a controller and a heating chamber, in which the aerosol generating article is removeable received. The power source may be aligned along a longitudinal axis of the heating chamber. The power source may be aligned along a second longitudinal axis, parallel to the longitudinal axis of the heating chamber.

The aerosol provision device may be configured for wireless charging. The aerosol provision device may be provided with a charging port, such as a USB port, which is used to couple the power supply to an external power source for recharging.

According to an aspect there is provided an aerosol provision system comprising: an aerosol provision device as described above; and an article comprising aerosol generating material.

The aerosol provision system may comprise a charging unit having a cavity for removably receiving the aerosol provision device. The charging unit may comprise a moveable lid, which covers the aerosol provision device in a closed configuration. The charging unit may comprise a user display. The user display may be visible to a user when the moveable lid is in a closed position and is partially or fully concealed or obscured from sight by the lid when the lid is an open position.

According to another aspect, there is provided a method of manufacturing a heater for an aerosol provision device comprising: providing an elongate housing having a longitudinal axis, locating a heating element within in the housing so that the heater extends in the direction of the longitudinal axis, providing a filler within the elongate housing to hold the heating element in the elongate housing; wherein the filler comprises a filler material and a particulate material; and the particulate material is electrically insulative and has a thermal capacitance that is lower than that of the filler material.

The method may comprise a further step of preforming the filler to a desired shape. The filler may be provided as a preformed element.

The method may further comprise providing one or more holes, slots, grooves, apertures or depressions at a base end of the heater, and at least partially filling the one or more holes, slots, grooves, apertures or depressions with a thermally insulating material.

The one or more holes, slots, grooves, apertures or depressions may be provided on an inner surface of the elongate housing. The method may comprise at least partially filling the one or more holes, slots, grooves, apertures or depressions with a thermally insulating material comprising the filler.

According to another aspect there is provided a method of generating aerosol comprising: providing an aerosol provision device comprising a heater as described above; and at least partially inserting an aerosol generating article into a receiving portion of the heating chamber.

### BRIEF DESCRIPTION OF THE DRAWINGS

Various embodiments will now be described, by way of example only, and with reference to the accompanying drawings, in which:

FIG. 1 shows a perspective view of an aerosol provision system including an aerosol provision device located within a charging unit;

FIG. 2 shows a schematic cross-sectional view of part of the aerosol provision device of FIG. 1;

FIG. 3 shows a schematic cross-sectional view of part of the aerosol provision device of FIG. 1 and an aerosol generating article of the aerosol provision system;

FIG. 4 shows a perspective view of another aerosol provision device;

FIG. 5 shows a schematic cross-sectional view of the device of FIG. 4;

FIG. 6 shows a schematic cross-sectional view of an embodiment of a heater which can be used in the device of FIG. 1 or FIG. 4;

FIGS. 7a, 7b and 7c are schematic cross-sectional views of further embodiments of a heater;

FIGS. 8a and 8b show embodiments of methods of manufacture of a heater;

FIGS. 9a, 9b and 9c show schematic cross-sectional views of the base end of a heater which can be used in the device of FIG. 1 or FIG. 4.

### DETAILED DESCRIPTION

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the non-combustible aerosol provision device may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

As used herein, the term “aerosol-generating material” is a material that is capable of generating aerosol, for example when heated, irradiated or energized in any other way. Aerosol-generating material may, for example, be in the form of a solid, liquid or semi-solid (such as a gel) which may or may not contain an active substance and/or flavourants.

The aerosol-generating material may comprise one or more active substances and/or flavours, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be continuous. For example, the film may comprise or be a continuous sheet of material. The sheet may be in the form of a wrapper, it may be gathered to form a gathered sheet or it may be shredded to form a shredded sheet. The shredded sheet may comprise one or more strands or strips of aerosol-generating material.

The aerosol-generating film may be discontinuous. For example, the aerosol-generating film may comprise one or more discrete portions or regions of aerosol-generating material, such as dots, stripes or lines, which may be supported on a support. In such embodiments, the support may be planar or non-planar.

The aerosol-generating film may be formed by combining a binder, such as a gelling agent, with a solvent, such as water, an aerosol-former and one or more other components, such as one or more substances to be delivered, to form a slurry and then heating the slurry to volatilise at least some of the solvent to form the aerosol-generating film.

An aerosol provision device can receive an article comprising aerosol generating material for heating. An “article” in this context is a component that includes or contains in use the aerosol generating material, which is heated to volatilise the aerosol generating material, and optionally other components in use. A user may insert the article into or onto the aerosol provision device before it is heated to produce an aerosol, which the user subsequently inhales. The article may be, for example, of a predetermined or specific size that is configured to be placed within or over a heater of the device which is sized to receive the article.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

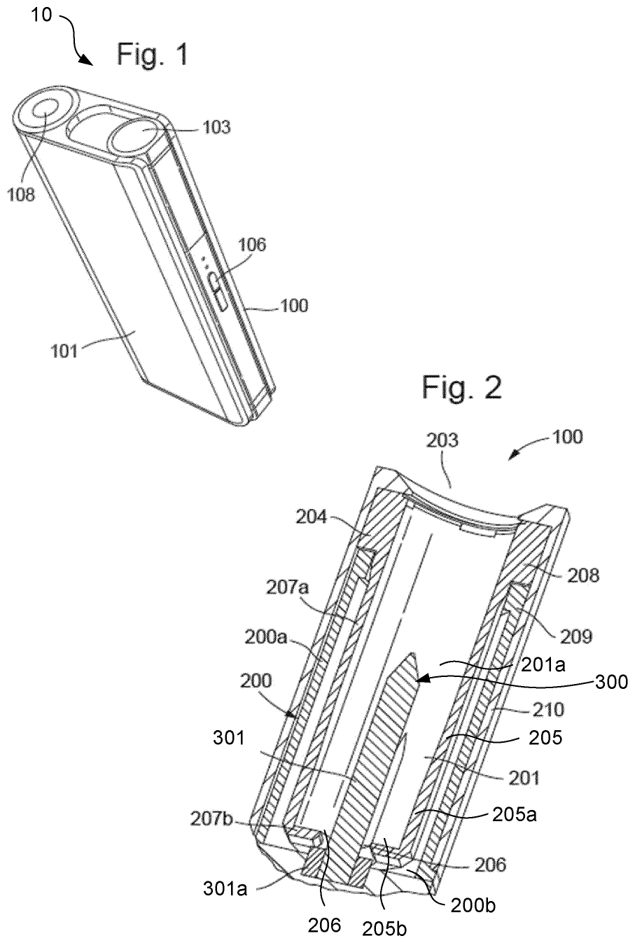

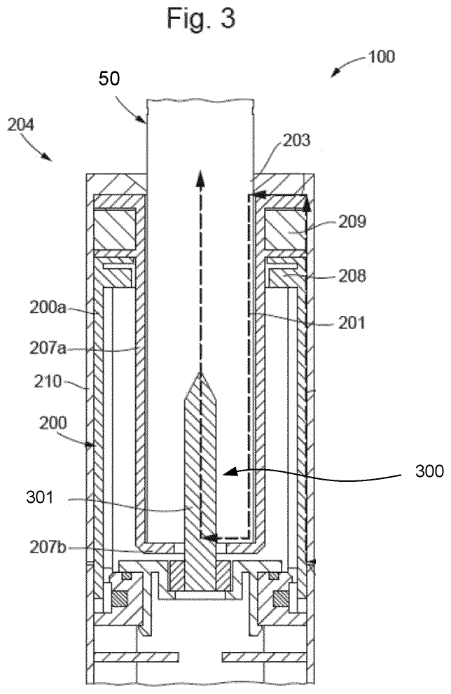

FIG. 1 shows an aerosol provision system 10 comprising an aerosol provision device 100 and a charging unit 101. The device is shown located within a cavity of a charging unit 101. The aerosol provision device 100 is arranged to generate aerosol from an aerosol generating article (refer to FIG. 3) which may be inserted, in use, into the aerosol provision device 100. In embodiments, the article forms part of the aerosol provision system 10.

The aerosol provision device 100 is an elongate structure, extending along a longitudinal axis. Additionally, the aerosol provision device has a proximal end, which will be closest to the user (e.g. the user's mouth) when in use by the user to inhale the aerosol generated by the aerosol provision device 100, as well as a distal end which will be furthest from the user when in use. The proximal end may also be referred to as the “mouth end”. The aerosol provision device 100 also accordingly defines a proximal direction, which is directed towards the user when in use. Further, the aerosol provision device 100 also likewise defines a distal direction, which is directed away from the user when in use. The terms proximal and distal as applied to features of the device 100 will be described by reference to the relative positioning of such features with respect to each other in a proximal-distal direction along a longitudinal axis. The aerosol provision device 100 comprises an opening at the distal end, leading into a heating chamber.

The aerosol provision device 100 may be removably inserted into the charging unit 101 in order to be charged. The charging unit 101 comprises a cavity (refer to FIG. 2) for receiving the aerosol provision device 100. The aerosol provision device 100 may be inserted into the cavity via an opening. The cavity may also comprise a longitudinal opening. A portion of the aerosol provision device 100 may comprise a first side. One or more user-operable control elements such as buttons 106 which can be used to operate the aerosol provision device 100 may be provided on the first side of the aerosol provision device 100. The first side of the aerosol provision device 100 may be received in the longitudinal opening provided in the charging unit 101.

In embodiments the cavity of the charging unit 101 may have a cross-sectional profile which only permits that the aerosol provision device 100 be inserted into the charging unit 101 in a single orientation. According to an embodiment the outer profile of the aerosol provision device 100 may comprise an arcuate portion and a linear portion. The cross-sectional profile of the cavity provided in the charging unit 101 may also comprise a similar arcuate portion and a linear portion. The linear portion of the cross-sectional profile of the cavity may correspond with the longitudinal opening.

The charging unit 101 includes a slidable lid 103. When the aerosol provision device 100 is inserted into the charging unit 101 in order to be recharged, the slidable lid 103 may be closed so as to cover the opening into the aerosol provision device 100. In other embodiments, the charging unit 101 may have an alternative lid configuration, such as a hinged or pivoted lid, or no lid may be provided.

The charging unit 101 may include a user interface such as display 108, which can be provided at any convenient location, such as in the position shown in FIG. 1.

FIG. 2 shows a cross sectional view of a portion of the aerosol provision device 100. The aerosol provision device 100 comprises a main housing 200. The main housing 200 defines a device body of the device 100. The device 100 defines a heating chamber 201. A receptacle 205 defines the heating chamber 201. An opening 203 is provided to provide access to the heating chamber 201. The receptacle 205 comprises a wall arrangement including a receptacle side wall 205a and a receptacle base 205b. The base 205b is at the distal end of the receptacle 205. A heating zone 201a is configured at least a portion of the article for heating.

A heater 301 is provided in a portion of the main housing 200 and the heater 301 extends or projects into the heating chamber 201. The heater 301 may comprise a base portion 301a which may be located in a recess provided in a portion of the body of the device 100. The heater 301 upstands in the heating chamber 201. The heater 301 upstands from the distal end.

The heater 301 comprises an elongate heating member in the form of a pin. The heater 301 in other embodiments comprises other elongate configurations, such as a blade. The heater 301 may be inserted, in use, into a distal end of an aerosol generating article 50 (refer to FIG. 3) which is received within the heating chamber 201 in order to internally heat the aerosol generating article.

The housing comprises housing wall 200a. The housing wall 200a extends along the longitudinal axis of the aerosol provision device 100, surrounding the heating chamber 201. The housing wall 200a may, at least in part, define a receiving chamber of the aerosol provision device 100, as the volume which is enclosed within the wall 200a. A housing base 200b is at the distal end of the housing wall 200a. In the shown embodiment, the heater 301 upstands from the housing base 200b. The heater 301 protrudes through the receptacle base 205b. An aperture 206 is formed in the receptacle base 205b through which the heater 301 protrudes. In embodiments, the heater 301 is mounted to the receptacle base 205b. The heater 301 upstands from the receptacle base 205b.

The aerosol provision device 100 further comprises a removal mechanism 204 which may be removably retained to the main housing 200 of the aerosol provision device 100. The removal mechanism 204 in embodiments is omitted. In embodiments, the housing wall 200a at least in part defines the receptacle 205. The removal mechanism 204 may be retained to the main housing 200 so that at least a portion of the removal mechanism 204 extends into the heating chamber 201. The removal mechanism 204 may comprise a longitudinal portion such as a peripheral wall portion 207a, which in the present embodiment is tubular, and a base wall portion 207b. The wall 207a may be a shape other than tubular, and may be any shape which encloses (e.g. encircles) and defines the heating chamber 201 there within.

In embodiments with the removal mechanism 204, the removal mechanism 204 defines the heating chamber 201. The removal mechanism 204 forms the receptacle 205. In embodiments in which the removal mechanism 204 is omitted, other features of the device 100 define the heating chamber 201, for example the housing side wall 200a and housing base 200b.

The base portion 207b has the aperture 206 through which the heater 301 may project. In order to retain the removal mechanism 204 to the main housing 200, the removal mechanism 204 is pushed into engagement with the main housing 200 in the distal direction, i.e. towards the distal end of the main housing 200, until the removal mechanism 204 is able to move no further in the distal direction. In the following description, when the removal mechanism 204 is referred to as being “retained to” the main housing 200, this is when the removal mechanism 204 is engaged with the main housing 200, and can move no further in the distal direction.

Together, the peripheral portion 207a and the base portion 207b may define and enclose an article chamber for receiving, the aerosol generating article 50, as shown in FIG. 3. The article chamber comprises an inner surface, which is configured to contact the aerosol generating article, the inner surface comprising a longitudinally extending portion which is provided by the tubular portion 207a, and an end portion which is provided by the base portion 207b. In embodiments, the article chamber and the heating chamber are the same. When the aerosol generating article 50 is received in the heating chamber, it may contact both the longitudinally extending portion of the inner surface, and the end portion of the inner surface. In particular, the article chamber (i.e. the peripheral portion 207a and the base portion 207b) may be configured to receive at least part of the aerosol generating article 50 which is in the form of rod which is longitudinally extending and cylindrical, such that the longitudinal axis of the article is parallel to (and optionally in line with) the longitudinal axis of the aerosol provision device 100 when received in the article chamber.

The article chamber may also be referred to as a receiving portion. When the removal mechanism 204 is retained to the main housing 200, in use, the article chamber of the removal mechanism 204 is arranged, at least partially, within the heating chamber 201. The heater 301 may be arranged so as to project into the article chamber, through the aperture 206 provided in the base portion 207b of the removal mechanism 204. The removal mechanism 204 is therefore configured to receive at least a portion of the aerosol generating article in use.

In embodiments, the removal mechanism 204 may comprise a first magnet or a magnetisable material 208. The main housing 200 may comprise a second magnet or magnetisable material 209. In use, the removal mechanism 204 may be magnetically retained to the main housing 200 by the interaction of the first magnet or magnetisable material 208 and the second magnet or magnetisable material 209.

In embodiments, the removal mechanism 204 is fully detachable from the main housing 200. The removal mechanism 204 may be retained to the main housing 200 by a magnetic force of attraction between the first magnet or magnetisable material 208 and the second magnet or magnetisable material 209. The removal mechanism 204 may be detached from the main housing 200 by overcoming the magnetic force between the first magnet or magnetisable material 208 and the second magnet or magnetisable material 209. In embodiments, the removal mechanism 204 is removably retained to the main housing 200 by other means. For example, the removal mechanism 204 may be configured to be removably retained to the main housing 200 by an interference fit with the main housing.

The removal mechanism 204 may comprise an internal element (comprising the tubular portion 207a and a base portion 207b) and an outer cap portion 210, wherein when retained to the main housing 200 the outer cap portion 210 encapsulates (e.g. covers) at least a portion of the main housing 200, such as the wall 200a of the main housing. The tubular portion 207a, base portion 207b and outer cap portion 210 may comprise an integral (e.g. unitary) component (formed, for example, by moulding).

Alternatively, the tubular portion 207a and base portion 207b may comprise a first component and the outer cap portion 210 may comprise a second separate component. The first and second components may then be secured together.

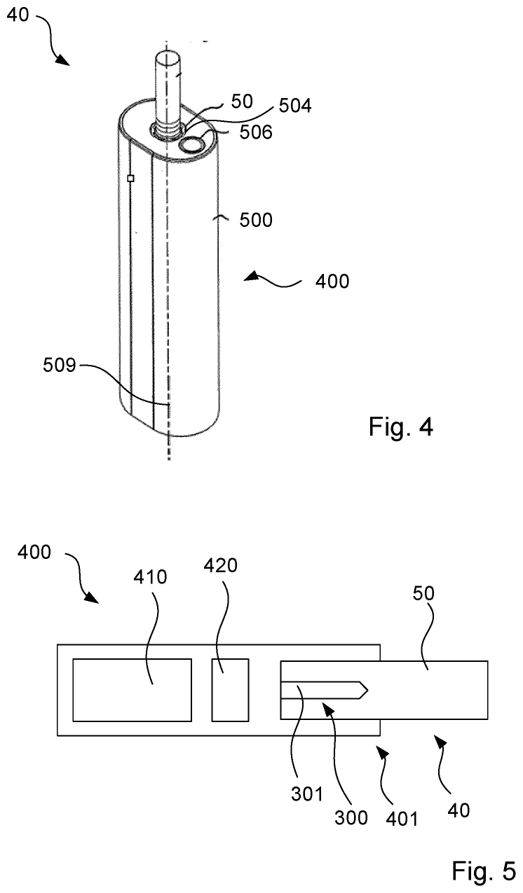

FIG. 4 shows another aerosol provision system 40. The system 40 comprises a one-piece aerosol provision device 400 for generating aerosol from an aerosol generating material, and the aerosol generating article 50 comprising the aerosol generating material. The device 400 can be used to heat the aerosol generating article 50 comprising the aerosol generating material, to generate an aerosol or other inhalable medium which can be inhaled by a user of the device 400.

The device 400 comprises a housing 500 which surrounds and houses various components of the device 400. The housing 500 is elongate. The device 400 has an opening 504 in one end, through which the article 50 can be inserted for heating by the device 400. The article 50 may be fully or partially inserted into the device 400 for heating by the device 400.

The device 400 may comprise a user-operable control element 506, such as a button or switch, which operates the device 400 when operated, e.g. pressed. For example, a user may activate the device 400 by pressing the switch 406.

The device 400 defines a longitudinal axis 509 along which an article 50 may extend when inserted into the device 400. The opening 504 is aligned on the longitudinal axis 509.

FIG. 5 shows a cross-sectional schematic view of the aerosol provision system 40. Features described with reference to FIG. 5 in embodiments are applicable to embodiments described above. The aerosol provision device comprises a power source 410, a controller 420 and a heating chamber 401, in which the aerosol generating article 50 is removeable received.

The one-piece device of FIG. 5 shows the power source 410 aligned along the longitudinal axis of the heating chamber 401. In another embodiment of a one-piece aerosol provision device, the power source is aligned along a second longitudinal axis, parallel to the longitudinal axis of the heating chamber.

The heater 301 comprises an elongate heater 301 in the form of a pin. The heater 301 in other embodiments comprises other elongate configurations, such as a blade, and can have a variety of cross-sectional shapes.

The heater 301 is provided in the heating chamber 401. The heater 301 of FIG. 5 and the heater 301 described above with reference to FIGS. 1 to 3, such that details described herein may be applied to each. The heater 301 extends or projects into the heating chamber 401.

The heater 301 may be inserted, in use, into a distal end of the aerosol generating article 50 which is received within the heating chamber 401 in order to internally heat the aerosol generating article 50.

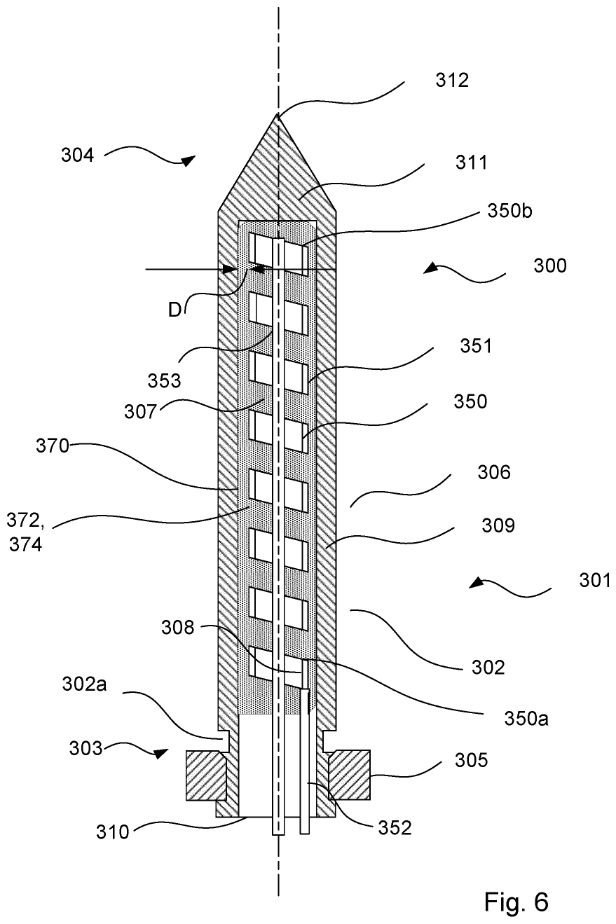

The aerosol provision devices 100, 400 comprise a heating arrangement 300. The heating arrangement 300 comprises a heater 301 (also referred to as a heating member). The heater 301 comprises a heating element 350 (refer to FIG. 6), such as a resistive heating coil, arranged to be actuated to heat the heating member.

The heating arrangement 300 is a resistive heating arrangement. The heater is a resistive heating heater. The heating element, such as a heating coil, as will be described below is a resistive heating element. In such arrangements the heating assembly comprises a resistive heating generator including components to heat the heating element via a resistive heating process. In this case, an electrical current is directly applied to a resistive heating element, and the resulting flow of current in the heating element, acting as a heating component, causes the heating element to be heated by Joule heating. The resistive heating element comprises resistive material configured to generate heat when a suitable electrical current passes through it, and the heating arrangement comprises electrical contacts for supplying electrical current to the resistive material. In embodiments, the heating element forms at least part of the resistive heating member itself. In embodiments the resistive heating element transfers heat to the heating member, for example by conduction. The provision of a resistive heating arrangement allows for a compact arrangement. Resistive heating provides an efficient configuration.

FIG. 6 shows the heater 301 for use in an aerosol provision device as described above. The heater 301 acts as or forms at least part of a heater. The heating arrangement 300 comprises the heater 301. The heater 301 comprises an elongate housing 302 and the heating element 350. The elongate housing 302 is an elongate member defining a longitudinal axis.

The housing 302 is formed from a thermally conductive material, such as aluminum. Other suitable materials, such as stainless steel may be used. The elongate housing 302 may comprise a coating on its outer surface. The elongate housing 302 is configured to transfer heat from the heating element 350 to the heating zone 201a within the aerosol provision device.

The elongate housing 302 has a base end 303 and a free end 304. The base end 304 mounts to the device body. A mount 305 at the base end 303 mounts the heater 301. It will be understood that different mounting arrangements may be used, for example a fixing, moulding, and bonding including adhering. The mount 305 may be a separate component or may be integrally formed with the elongate housing 302.

The elongate housing 302 comprises a housing body 306. The housing body 306 is tubular. In other embodiments, the housing body may 306 have a variety of cross-sectional shapes, such as but not limited to, circular, elliptical, rectangular, pentagonal, hexagonal, octagonal.

The housing body 306 comprises a bore 307. The bore 307 defines an inner void (or cavity) 308 of the heater 301. The inner void 308 extends longitudinally. An inner surface 309 is defined on an inner side of the elongate housing 302. An open end 310 to the inner void 308 is provided at the base end 303.

The free end 304 of the elongate housing 302 extends towards the proximal end of the heating chamber. The free end 304 of the heater 301 is closed, in other words, the inner void 308 does not extend through the free end 304. A tip 311 is provided at the free end 304. The tip 311 extends to an apex 312. Other shapes and configurations of the tip 311 may be provided, for example the tip 311 may define a planar surface.

The heating element 350 is located within elongate housing 302 of the heater 301. The heating element 350 extends in the elongate housing 302 in the longitudinal direction and has a base end 350a and a free end 350b. The heating element 350 is received in the inner void 308. In FIG. 6, the heating element 350 extends between the base end 303 and the free end 304. In some embodiments, the heating element extends partially along the length of the inner void 308. In some embodiments the heating element 350 extends to or beyond the open end 310.

The heating element 350 in embodiments comprises a heating coil 351. The heating coil 351 comprises a resistive member defining the heating coil 351.

The heating coil 351 is a resistive heating coil. The heating coil 351 is a helical coil. The heating coil 351 has a rectangular cross-sectional profile. It will be understood that other coil configurations are possible. In embodiments, the heating coil 351 has a circular cross-sectional profile. In embodiments, the heating arrangement 300 comprises two or more heating coils.

The heating arrangement 300 comprises electrical connection paths 352, 353. The electrical connection paths extend from each end of the heating element 350. A base electrical connection path 352 extends from the distal end of the heating element 350. A return electrical connection path 353 extends from the proximal end of the heating element 350. The return electrical connection path overlaps the longitudinal extent of the heating element 350. The electrical connection paths are integrally formed with the heating element, for example as a single wire. In embodiments, connectors connect the electrical connection paths with the heating element 350. The heating coil 351 is formed from a resistive material, such as a nickel/chrome alloy such as nichrome 80/20(80 % Nickel, 20% Chromium), an iron/chrome/aluminium alloy, or a copper/nickel alloy.

The heating arrangement 300 further comprises a filler 370 located within the inner void 308. The filler 370 is in contact with at least a portion of the inner surface 309 of the inner void 308 and a portion of the heating element 530. This means that the filler 370 holds the heating element 350 within the housing body 306. The heating element 350 is substantially aligned with the axis 509 to provide optimised, consistent heating to the elongate housing 302. This means that in use, when an aerosol generating article is inserted into an aerosol provision device, there is consistent heating along the length of the heater 301 in order to internally heat the aerosol generating article 50.

The filler 370 is located between the inner surface 309 of the inner void 308 and an outer surface of the heating element 350.

The filler 370 is a thermally conductive material to provide for effective heat transfer from the heating element 350 to the housing body 306 of the elongate housing 302.

The filler 370 comprises a filler material 372 and a particulate material 374 disbursed through the filler material 372, and the particulate material 374 has a lower thermal capacitance than the filler material 372.

The provision of particulate material having a lower thermal capacitance than the filler material means that less energy is adsorbed by the filler and more of the energy generated by the heating element is transferred to the elongate housing of the heater. In other words, less energy is required to heat the heater assembly which results in faster transfer of heat to the elongate housing.

The particulate material 374 is dispersed through-out the filler material. It will be understood that the term particulate material comprises one or more of microspheres, strands or fibres.

In some embodiments, the filler 370 is an electrically insulating material in order to electrically insulate the housing 302 from the heating element 350, in other words the filler 370 prevents the heating element 350 from coming into electrical contact with the inner surface 309 of the elongate housing 302.

In other embodiments, the heating element 350 may be provided with an electrically insulating coating (dielectric coating). Where such a coating is provided on the heating element, the filler 370 does not need to provide the electrical insulation.

In the embodiment of FIG. 6, a single portion of filler material 370 is provided. the heating element has a length corresponding to the length of the inner void 308, and the filler material 370 substantially fills the inner void 308 and holds the heating element 350 centrally, aligned with the axis 509.

As shown in FIG. 6, a distance D is defined between the inner surface 309 of the inner void 308 and the outer surface of the heating element 530. In embodiments, the filler 370 may comprise particulate material 374 with a median particle size less than D which means that the portion of filler 370 located between the heating element 530 contains a restricted amount of particulate material. This ensures that the heating element 530 is in close proximity to the inner surface 309 and heat can be efficiently transferred from the heating element 350 to the elongate housing 302.

It will be appreciated that the particle material can be selected to provide an optimum solution for any given heater and heating element specification and geometry. To provide maximum heat transfer between the heating element and the elongate housing, the distance D should be minimised, whilst also ensuring electrical insulation. It is considered that a good thermal transfer would be achieved with D between about 1 μm and about 65 μm, and a particulate material having a median particle size greater than D. It will be appreciated that manufacturability of the heater and availability of particulate material may also need to be taken into account in any optimisation of the distance D.

It will be appreciated that when a heating element is provided with dielectric coating, the filler does not provide electric insulation and so D can be reduced such that the heating element is in contact with the housing at one or more positions along its length.

Whilst the distance D is shown on FIG. 6, it will be appreciated that this can be applied to all embodiments described below.

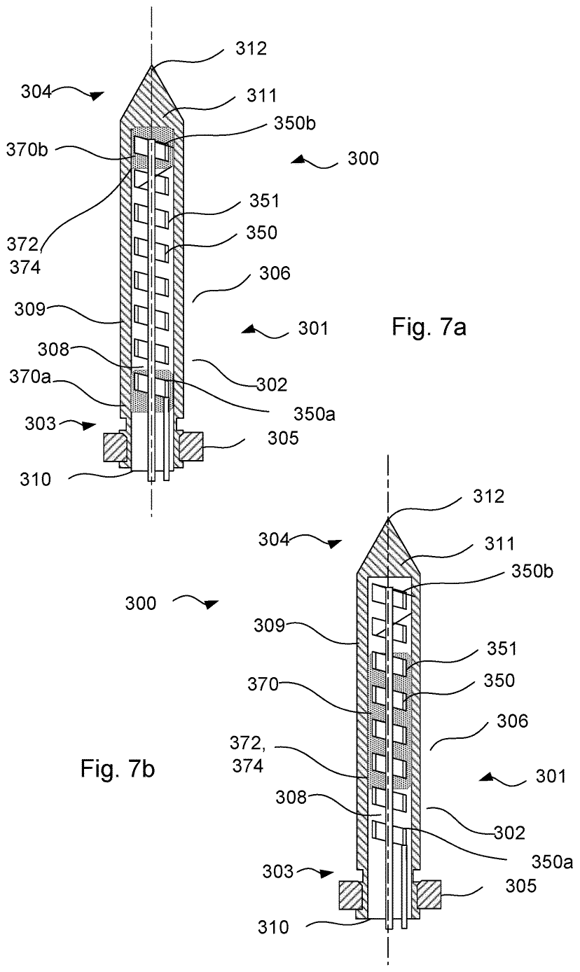

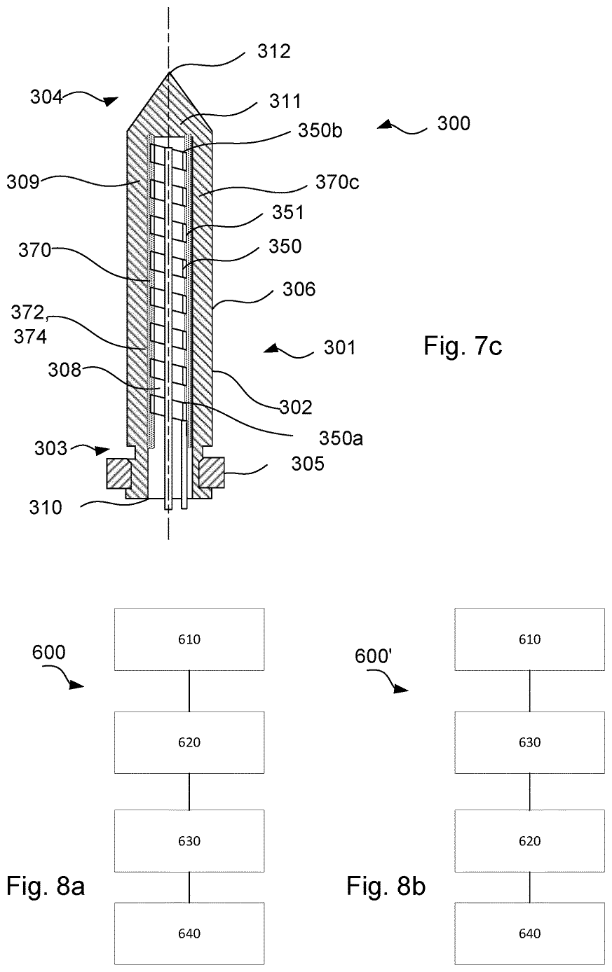

FIG. 7a shows an alternative embodiment in which two discrete portions of filler 370a and 370b are provided at the base end 350a and the free end 350b of the heating element 350, such that there is an air gap between the two discrete portions filler 370a and 370b.

FIG. 7b shows a further embodiment in which one portion of filler 370 is provided at a central portion of the heating element 350, securing the heating element 350 to a central portion of the housing body 306.

In other embodiments one portion of filler is provided at a central portion of the heating element, extending along at majority of the length of the heating element.

FIG. 7c shows another embodiment in which portions of filler 370c are provided extending axially between an outer surface of the heating element 350 and an inner surface 309 of the inner void 308, such that the filler portions 370c define generally axially orientated passages between adjacent portions 370c, each passage is configured to allow the passage of air along the passage. In a basic arrangement, two portions of filler 370c are provided diametrically opposite each other. In other embodiments, three, four, five or six portions are provided, spaced around the inner surface 308 such that a corresponding number of axially oriented passages are provided.

In other embodiments, a single discrete portion of filler can be provided at either the base end or the free end of the heating element.

In other embodiments, two or more discrete portion of filler can be provided at a central portion of the heating element, or multiple discrete portions of filler can be provided along the length of the coil. The discrete portions of filler can be equally spaced or provided at any convenient spacing.

The heater 300 as described above may be manufactured by a method, schematically shown in FIG. 8a) comprising: providing the elongate housing 302 (step 610), inserting the heating element 350 into the elongate housing 302 (step 620) and then adding the one or more discrete portions of filler 370 into the elongate housing so as to hold the heating element 350 in place (step 630).

In an alternative method of manufacture 600′ (schematically shown in FIG. 8b), the one or more discrete portions of filler 370 may be provided as preformed elements which are applied on or around the heating element 350 (step 520) before it is inserted into the elongate housing 302 (step 630).

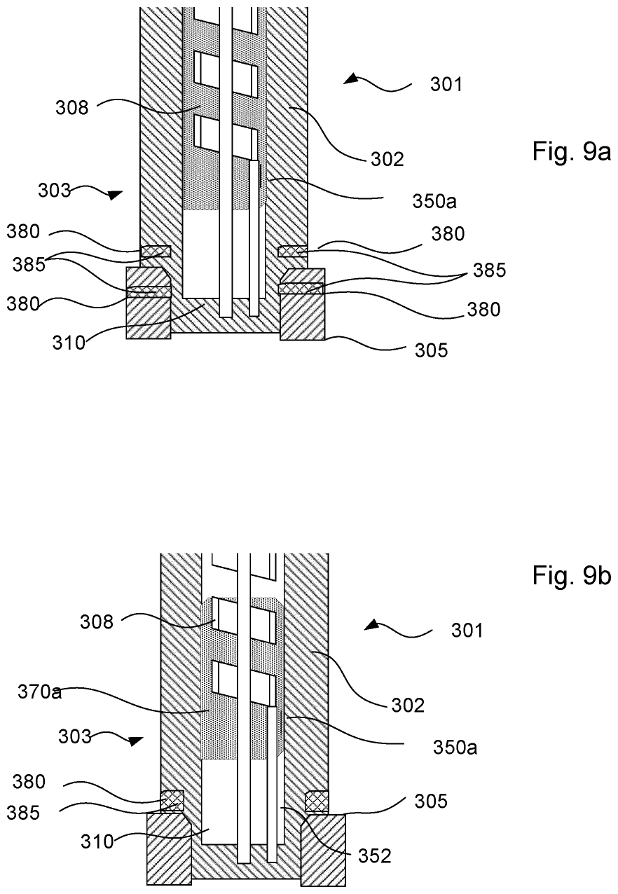

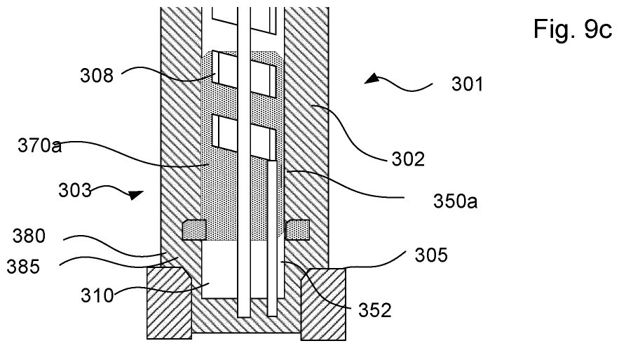

FIGS. 9a to 9c shows further embodiments of the base end 302 of a heater 301 with a discrete portion of filler 370 at the distal end 305. However, it will be appreciated that these may be a heater having any filler arrangement as described above.

In FIG. 9a, the base end of the elongate housing 302 is provided with two through-holes 380 which are at least partially filled with a thermally insulating material 385, such as, but not limited to, a potting compound, an adhesive, a thermosetting plastic or an epoxy resin. The mount 305 of the heater 301 is also provided with two through-holes 380 which are at least partially filled with a thermally insulating material 385.

The thermally insulating material 385 is provided in the region of the heater 301 below the heating element 350, in other words below the region of the elongate housing 302 which is inserted into the article comprising aerosol generating material. The thermally insulating material 385 provides a thermal break which reduces heat transmission to the base end 303 of the heater, which does not need to be heated in use. Further, when the heater 301 is mounted in an aerosol provision device (as shown for example in FIGS. 1 to 5), heat transmission to the main housing of the device is reduced.

In other embodiments, one or more through-holes which are at least partially filled with the thermally insulating material are provided in only one of the base ends of the housing and the mount.

The thermally insulating material 385 may be the filler 370 described above, or another suitable material.

It will be appreciated that FIG. 9a shows two through-holes provided on opposite sides of the heater. However, it will be appreciated that in other embodiments, any suitable number of through holes can be provided in the base end of the housing and/or the mount.

Whilst through holes at least partially filled with thermally insulating material are described above, it will be appreciated that other embodiments include alternative configurations of this type of thermal break.

FIG. 9b shows an alternative in which a circumferential grove or ridge 380 is provided in an outer surface of the base end 303 of the elongate housing 302, which is at least partially filled with a thermally insulating material 385. The thermally insulating material 385 may be the filler 370 described above, or a different material.

In other embodiments, one or more slots, grooves, apertures or depressions are provided in the base end of the elongate housing and/or the mount and the one or more holes, slots, apertures or depressions are at least partially filled with a thermally insulating material.

FIG. 9c shows an alternative in which a circumferential groove 308 is provided on the inner surface 309 of the inner void 308, and the filler 370 is provided in the groove 308.

Whilst a groove is shown in FIG. 9c, it will be appreciated that other similar configurations of thermal break can be provided. In other embodiments, one or more slots, grooves, apertures or depressions are provided in the inner surface of the elongate housing and are at least partially filled with the filler 370 that is provided in the inner void 308.

The thermally insulating material 385 is applied to the heater 301 in step 640 of the methods 600 and 600′, as shown in FIG. 8a an 8b.

In the above described embodiments, the heating arrangement is a resistive heating arrangement. In embodiments, other types of heating arrangement are used, such as inductive heating. The configuration of the device is generally as described above and so a detailed description will be omitted.

An inductive heating arrangement comprises various components to heat the aerosol generating material of the article via an inductive heating process. Induction heating is a process of heating an electrically conducting heating member (such as a susceptor) by electromagnetic induction. An induction heating arrangement may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor (heating member) suitably positioned with respect to the inductive element. In inductive heating, as compared to heating by conduction for example, heat is generated inside the susceptor, allowing for rapid heating. Further, there need not be any physical contact between the inductive element and the susceptor, allowing for enhanced freedom in construction and application.

In inductive heating heat is generated in the susceptor (heating member) whereas in resistive heating heat is generated in the coil (heating element).

In embodiments, the heating member of the aerosol provision system is a part of the aerosol generating article, rather than being a part of the aerosol provision device. The heating element may be a resistive heating element, for example in the form of the resistive coil described above, which is provided as part of the aerosol generating article. Electrical connections may enable electric current to flow through the resistive heating element.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A heater for an aerosol provision device configured to heat at least a portion of an article containing aerosol generating material, wherein the heater comprises:
an elongate housing;
a heating element located within the elongate housing; and
a filler located within in the elongate housing;
wherein the heating element is held in the elongate housing by the filler;
wherein the filler comprises a filler material and a particulate material; and
wherein the particulate material is electrically insulative and has a thermal capacity that is lower than that of the filler material.

2. The heater according to claim 1, wherein at least two discrete portions of filler are provided.

3. The heater according to claim 2, wherein the elongate housing defines a longitudinal axis, and the at least two discrete portions of filler are spaced from each other along the longitudinal axis.

4. The heater according to claim 1, wherein at least one discrete portion of filler is provided at a first end of the heating element.

5. The heater according to claim 1, wherein at least one discrete portion of filler is provided at a second end of the heating element.

6. The heater according to claim 1, wherein at least two discrete portions of filler are provided extending axially along an inner surface of the elongate housing.

7. The heater according to claim 1, wherein a single discrete portion of filler is provided.

8. (canceled)

9. The heater according to claim 1, wherein the particulate material comprises microspheres.

10. The heater according to claim 1, wherein the particulate material comprises fibres and/or strands.

11. The heater according to claim wherein the particulate material has a density of less than about 0.65 g/cm3 , such as from about 0.1 g/cm3 to about 0.5 g/cm3 .

12. The heater according to claim 1, wherein the particulate material comprises glass.

13. The heater according to claim 1, wherein the particulate material has a median particle size of about 15 to about 500 μm.

14. The heater according to claim 1, wherein the particulate material has a thermal capacitance of between about 700 J·kg⁻¹·K⁻¹ and about 1100 J·kg⁻¹·K⁻¹.

15. The heater according to claim 1, wherein the filler material comprises an inorganic material.

16. The heater according to claim 1, wherein the heater element comprises at least one heater coil.

17. The heater according to claim 1, wherein the heating element is a resistive heating element.

18. The heater according to claim 1, wherein the elongate housing comprises one or more holes, slots, grooves, apertures or depressions, wherein the one or more holes, slots grooves, apertures or depressions are provided at a base end of the heater, and are at least partially filled with a thermally insulating material.

19. An aerosol provision device configured to heat an article containing aerosol generating material, the device comprising a heater according to claim 1.

20. A system comprising a device having a heater according to claim 1 and an article comprising aerosol generating material.

21. A method of manufacturing a heater for an aerosol provision device comprising, the method comprising:
providing an elongate housing having a longitudinal axis,
locating a heating element within in the housing so that the heater extends in the direction of the longitudinal axis, and
providing a filler within the elongate housing to hold the heating element in the elongate housing;
wherein the filler comprises a filler material and a particulate material; and the particulate material is electrically insulative and has a thermal capacitance that is lower than that of the filler material.
